(19) United States
(12) Patent Application Publication
(10) Pub. No.: US 2025/0307641 A1
(43) Pub. Date: Oct. 2, 2025

(54) AUTOMATIC METADATA GENERATION DURING MACHINE LEARNING MODEL TRAINING

(71) Applicant: NVIDIA Corporation, Santa Clara, CA (US)

(72) Inventors: Michael Boone, San Jose, CA (US); Carl Everett Lacey, JR., Palo Alto, CA (US); Nikki Delight Pope, San Jose, CA (US); Ruthie Lyle, Durham, NC (US)

(21) Appl. No.: 18/623,782

(22) Filed: Apr. 1, 2024

(51) Int. Cl. G06N 3/092

(52) U.S. Cl. CPC G06N 3/092

(57) ABSTRACT

In various examples, metadata associated with one or more models may be captured during a training process and stored in association with the model(s). The metadata may then be used, in some embodiments, for enforcing execution of the model(s). For instance, the model(s) may be trained during at least a portion of the training process. During at least a second portion of the training process, one or more attributes associated with the model(s) may be determined. The attribute(s) may then be stored as metadata in association with the model(s). Additionally, in some embodiments, an endpoint may request to execute the model(s). Responsive to the request, and based at least on evaluating the metadata with respect to one or more criteria associated with the endpoint, a determination may be made regarding whether or not to provide the model(s) to the endpoint for execution.

### BACKGROUND

Models (e.g., machine learning models, neural networks, etc.) may be used in a wide variety of applications, including, but not limited to, healthcare, finance, transportation, manufacturing, and/or entertainment. For instance, in healthcare-related contexts, AI-powered systems may assist in diagnosing diseases, analyzing medical images, and/or personalizing treatment plans. In contrast, models used for transportation-related contexts may enable machines (e.g., semi-autonomous and/or fully autonomous vehicles) to perceive their surroundings and navigate safely. Consequently, different models may be adapted for different uses and/or possess different strengths and weaknesses, even when comparing different models within the same context (e.g., transportation).

To help understand the capabilities, limitations, and/or differences between models, end users may evaluate model metadata (e.g., model cards, etc.) associated with models. This model metadata is often kept separate from a model and contain various information about that particular model, such as the model's development process, training data, performance metrics, potential biases, limitations, intended use cases, and/or out of scope applications, which may allow the end users to make informed decisions about the model's deployment and/or use. Model metadata may also help support compliance with regulatory standards and/or industry best practices. As such, organizations may use model metadata to demonstrate adherence to various requirements, such as legal requirements, corporate compliance requirements, and/or ethical requirements, which may help ensure AI systems are developed and/or deployed in a manner that aligns with societal values and norms.

However, different phases of model development (e.g., training, evaluation, deployment, etc.) may, in some instances, be performed by different teams, which may not have access to all of the information available to previous teams or during previous phases of development. Similarly, the process of adding information to the model metadata may also be provided by a disparate team, if at all, using one or more manual processes, which may introduce opportunities for unintended errors. Moreover, the separation of the model metadata from the model itself may require model consumers and/or developers to be proactive in seeking, validating, and/or pairing model metadata to the model under consideration. Additionally, while model metadata provides guidance for the best use of a model, the appropriate use of the model may still be left to the discretion of the end user. That is, once a model has been deployed, there is no assurance that the model will be used appropriately for its intended use.

### SUMMARY

Embodiments of the present disclosure relate to automated model metadata generation during training of AI systems. Systems and methods are disclosed for capturing metadata (e.g., model metadata, model card data, etc.) associated with one or more models (e.g., machine learning models, AI models, etc.) during a training process and storing the captured metadata in association with the model(s) (e.g., in a model archive). The systems and methods disclosed herein may also use the metadata to manage (e.g., influence, constrain, control, etc.) the execution of the model(s) by end users and/or systems.

In contrast to conventional systems, such as those described above, the systems of the present disclosure are able to advantageously reduce the number of unintended errors typically associated with manual generation of model metadata by automatically capturing the model metadata in real time during the training process. For instance, the systems of the present disclosure may include, e.g., during the training process, an execution of one or more software libraries to obtain the model metadata during at least a portion of the training process. Additionally, or alternatively, the software library (ies) may include instructions for computing risk and/or bias scores associated with the model(s) during the training process. The systems may also store the model metadata in association with the model(s) (e.g., in model archives), which may allow end users to find, validate, and/or pair model metadata with the model under consideration more easily, as opposed to conventional systems. For instance, the software library (ies) used to modify the training process may further include instructions to cause the model metadata to be automatically stored in association with the model(s).

Additionally, in contrast to conventional systems, the systems of the present disclosure may, in some embodiments, use the model metadata to at least partially control execution of the model(s). For example, when end users/systems request the model(s), the current systems may evaluate the model metadata with respect to policies associated with the end users/systems, hardware capabilities of the end users/systems, and/or the like. Based at least on this evaluation, the systems may determine whether or not to provide the model(s) to the end users/systems, which may facilitate a level of control over the model(s) for enforcing model execution. By way of example, and not limitation, the systems of the present disclosure may prevent model execution when the model may be noncompliant within the constraints of an enterprise and/or not optimized for an end user's/system's execution environment.

### BRIEF DESCRIPTION OF THE DRAWINGS

The present systems and methods for model metadata generation and enforcement for AI systems and applications are described in detail below with reference to the attached drawing figures, wherein:

FIG. 1A is a data flow diagram illustrating an example process for capturing model metadata during a training process and storing the model metadata in association with one or more models, in accordance with some embodiments of the present disclosure;

FIG. 1B is a data flow diagram illustrating an example process for querying model metadata and/or using model metadata to enforce execution of the model(s), in accordance with some embodiments of the present disclosure;

FIG. 2 is a data flow diagram illustrating an example process for enforcing execution of one or more models based at least on model metadata, in accordance with some embodiments of the present disclosure;

FIG. 3 is a flow diagram illustrating an example method for obtaining model metadata during a training process, in accordance with some embodiments of the present disclosure;

FIG. 4 is a flow diagram illustrating another example method for determining model metadata during a training process and storing the model metadata in association with one or more model(s), in accordance with some embodiments of the present disclosure;

FIG. 5 is a flow diagram illustrating an example method for enforcing execution of one or more models based at least on model metadata stored in association with the model(s), in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to model metadata generation during training of AI systems and enforcement for AI systems using the same. For instance, a system(s) may generate one or more first libraries (e.g., software libraries) that include one or more instructions for obtaining metadata associated with one or more models (e.g., AI models, machine learning models, etc.). In some embodiments, the metadata may include one or more attributes associated with the model(s). As described herein, the attribute(s) may include, but is not limited to, a name and/or an identifier of the model(s), names and/or identifiers of one or more datasets used to train the model(s), a size of the dataset(s), a number of epochs using for the training, a license type associated with the model(s), a risk score associated with the model(s), bias scores associated with the model(s), losses associated with the model(s), and/or the like. Additionally, in some embodiments, the metadata may indicate, but is not limited to, intended use cases for the model(s), out-of-scope applications for the model(s), expected users of the model(s), how the model(s) performs with different demographic groups, information about the data used to train and/or verify the model(s), limitations of the model(s), hardware (e.g., CPU, RAM, GPU, etc.) requirements for executing the model(s), and/or ethical considerations associated with the model(s).

In some embodiments, the system(s) may modify a training process (e.g., software framework, script, etc.) for training the model(s) such that, during the training process, the metadata associated with the model(s) is automatically obtained or otherwise determined. For example, the training process may include one or more second libraries that include one or more second instructions associated with training the model(s). The system(s) may, in some embodiments, wrap the second library (ies) for training the model(s) with the first library (ies) for obtaining the metadata. For example, the system(s) may create one or more instances of the first library (ies) and use the instance(s) to evoke the model training (e.g., the second library (ies)). In this way, the functionality of the first library (ies) for obtaining the metadata may be extended to the training process and/or the second library (ies), and the metadata may be obtained during at least a portion of the training process. In some examples, the modified training process may train the model(s) during a first portion of the process, obtain/determine the metadata during a second portion of the process, and store the metadata in association with the model(s) during a third portion of the process.

In some embodiments, the system(s) may compute one or more model uncertainty values associated with the model(s) and store this value(s) as part of the metadata. For instance, the first library (ies) may include instructions for using one or more algorithms to calculate risks associated with the model(s), bias associated with the model(s), a variance associated with the model(s), confidence intervals associated with the model(s), calibration values associated with the model(s), and/or the like.

In some embodiments, the system(s) may store the metadata in association with the model(s). For instance, during the training process and/or thereafter, the system(s) may store the trained model(s) and/or the metadata in association with one another. By way of example, and not limitation, the system(s) may store the metadata within one or more files (e.g., bundled with the model(s)), in one or more databases associated with a platform (e.g., a cloud-delivered service), in one or more model archives, and/or the like. In some embodiments, the system(s) may generate one or more model cards that include at least a portion of the metadata. The model card(s) may be stored in association with the model(s) similarly to the metadata as described above (e.g., within a model archive, bundled with the model(s) in a file, etc.).

In some embodiments, based at least on storing the metadata and/or model card(s) in association with the model(s), the system(s) may enable end users and/or systems to easily query and/or access the metadata/model card(s) associated with a given model. For instance, end users and/or systems may query and receive any information included in the metadata and/or model card, such as training details, risk scores, bias details, hardware specifications for optimal performance, and/or the like. For example, the system(s) may receive a query for the metadata from an endpoint (e.g., user, device, system, etc.). In response the system(s) may obtain the metadata (e.g., from a model archive, from the bundled file, etc.) and provide the metadata to the endpoint.

As described herein, the system(s) may also enforce execution of the model(s) based at least on criteria checked against the metadata and/or the model card(s). In this way, the system(s) may prevent the model(s) from executing in scenarios that would be, for instance, non-compliant within the constraints of an enterprise, not optimized for the execution environment, and/or the like. The enforcement of model execution at runtime may enable users and/or organizations to restrict the model(s) from executing based at least on factors like the model(s) license, training data, risk assessment, bias, and/or the like.

For instance, the system(s) may receive, from one or more endpoints, a request to execute a model on one or more devices associated with the endpoint(s). The request may indicate a specific model of the model(s) that the endpoint(s) is/are requesting to execute. Based at least on the request, the system(s) may obtain at least the metadata stored in association with that specific model. Using the metadata and the information known about the requesting endpoint(s), the system(s) may determine whether to provide the model to the endpoint.

In some embodiments, the system(s) may evaluate the attribute(s) and/or other information included in the metadata with respect to one or more criteria associated with the endpoint. For instance, the criteria may include a policy associated with the endpoint (e.g., an enterprise policy, etc.) that indicates various requirements for the model(s) that may be used. As an example, the policy may indicate, among other things, risk thresholds for models, license requirements for models, training requirements for models, etc. Additionally, or alternatively, the criteria may include hardware specifications indicating one or more limitations and/or capabilities associated with the device(s) of the endpoint(s) that are to execute the model(s). For instance, the hardware specification may indicate features (e.g., type of processor, make of processor, model of processor, etc.) associated with one or more processors of the device(s), memory limitations and/or capabilities associated with the device(s), version numbers associated with the device(s), etc.

In some embodiments, the system(s) may determine that the endpoint(s) and/or device(s) is allowed and/or capable of executing the requested model(s). For instance, based at least on the evaluation, the system(s) may determine that a model is in compliance with a given set of requirements (e.g., which may be indicated in the policy), that the model is optimized for the execution environment of the endpoint(s), and that the device(s) hardware is able to properly execute the model. The system(s) may then send, to the endpoint, data for executing the model(s) on the device(s). Additionally, or alternatively, if the system(s) determine that the endpoint(s) and/or device(s) are prevented from executing the model(s), the system may send an indication to the endpoint(s). In some embodiments, the indication may indicate one or more reasons why the model(s) are prevented from executing on the endpoint(s). For example, the indication may indicate that the policy restricts the endpoint(s) from executing the requested model(s) and/or that the capabilities/limitations of the device(s) may prevent the requested model from being executed.

For example, the metadata may indicate a risk score associated with the requested model(s), and the system(s) may evaluate this risk score with respect to a risk threshold associated with the endpoint(s) (e.g., indicated in the policy). Based at least on the evaluation, the system(s) may determine whether or not to provide the data to the endpoint(s) for executing the model(s). That is, if the model risk score meets or exceeds the risk threshold, the system(s) may determine to preclude the model(s) from execution on the endpoint(s). However, if the model risk score is less than the risk threshold, the system(s) may determine to allow the model(s) to be executed by the endpoint(s).

As another example, the system(s) may determine, based at least on the metadata, one or more thresholds corresponding to one or more hardware capabilities for executing the model(s). Example thresholds may include, but are not limited to, a central processing unit (CPU) threshold, a graphics processing unit (GPU) threshold, a data processing unit (DPU) threshold, a network hardware unit threshold, a memory threshold, and a network bandwidth threshold. The system(s) may then evaluate actual capabilities associated with the device(s) of the endpoint(s) with respect to the one or more hardware threshold(s) to determine whether or not to provide the data to the endpoint(s) for executing the model(s). If the system(s) determine the actual capabilities meet or exceed the threshold(s), the system(s) may determine to provide the model(s) to the endpoint(s). However, if the actual capabilities do not meet the threshold(s), the system(s) may determine to prevent the model(s) from being executed by the endpoint(s).

In some embodiments, the system(s) may propose one or more alternatives (e.g., better suited, more capable, etc.) model(s) to the endpoint(s). In some embodiments, the alternative model(s) may be proposed to the endpoint(s) based at least on determining that the endpoint(s) is prevented from executing a requested model. Additionally, or alternatively, the endpoint(s) may query the system(s) for a model(s) that meet certain prerequisites, for intended purposes, etc. By way of example, and not limitation, the endpoint(s) may request a model for detecting objects in an environment of a machine, that has been trained using a closed source (e.g., non-open source) dataset, and that is optimized for rural environments. Based on this request, the system(s) may evaluate metadata and/or one or more model cards for one or more proposed models that would meet these requirements. In some embodiments, the system(s) may further provide the metadata and/or the model card(s) corresponding to the proposed model(s) to the endpoint(s), and the endpoint(s) may select which model(s) to execute.

The system(s) may, in some embodiments, allow for a variety of metadata queries to be executed. For example, the system(s) may allow for model verification by allowing users and/or systems to verify, before executing a model, whether the model complies with the intended use, license, and/or enterprise requirements. The system(s) may also provide for optimized execution by allowing users and/or systems to place the model(s) in appropriate environments by querying the metadata when determining how to deploy or manage the model for the best performance. Additionally, with increasing demands for AI transparency, the system(s) may help offer a standardized way to understand a model's background, training, and characteristics, thereby promoting trust among end-users. Further, the system(s) may include a multimodal interface that is able to take audio inputs in addition to tactile/written, which may extend transparency to those end users with differing abilities (e.g., those with impaired hearing, sight, etc.).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

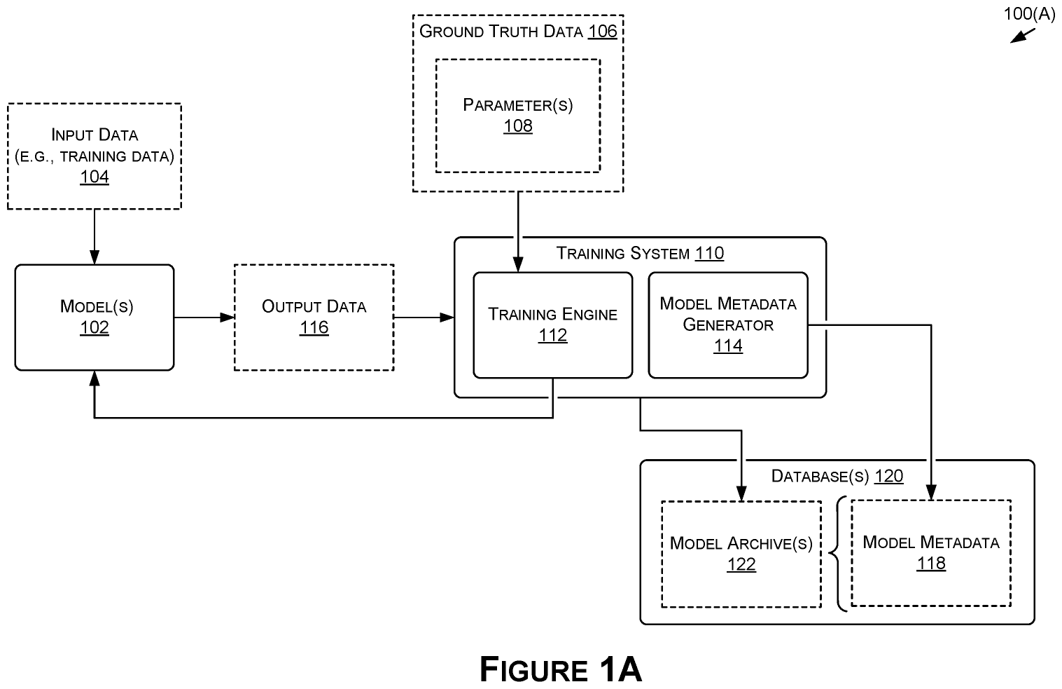

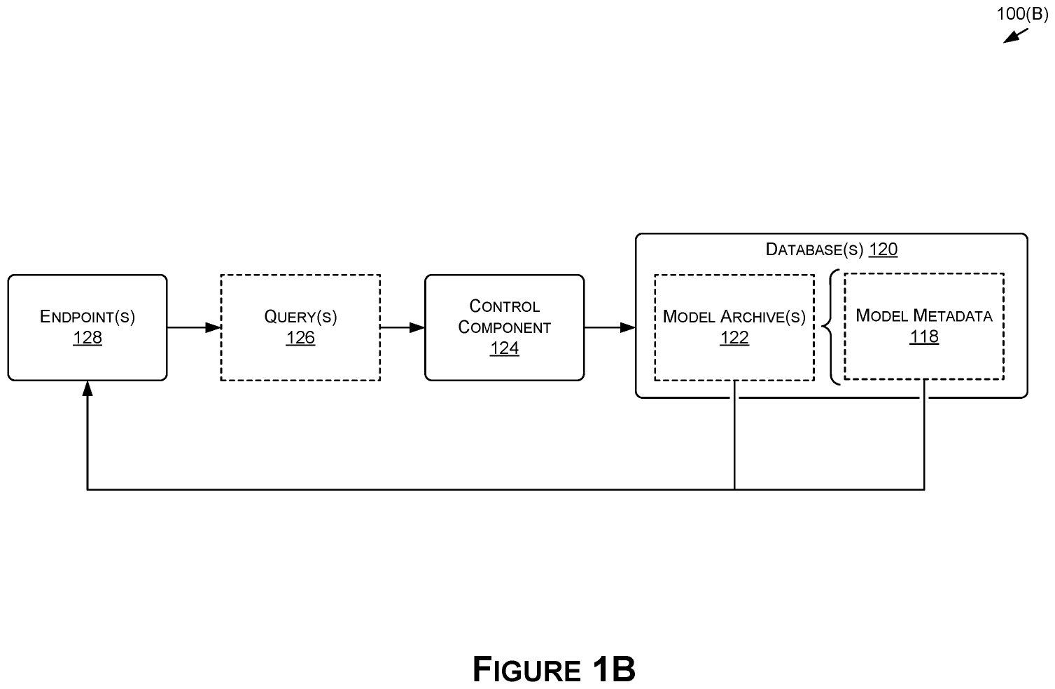

With reference now to FIG. 1A, FIG. 1A is a data flow diagram illustrating an example process 100(A) for capturing model metadata during a training process and storing the model metadata in association with one or more models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100(A) includes one or more model(s) 102 that may be trained using input data 104 (e.g., training data). The input data 104 may include structured, unstructured, and/or semi-structured data for model development. In some examples, the input data 104 may vary in size, quality, and/or complexity, thereby enabling the model(s) 102 to learn patterns, relationships, and/or structures within the input data 104. The input data 104 may include similar data to what a trained version of the model(s) 102 may expect to receive as inputs during execution (e.g., inference, prediction, etc.). For a first example, if the model(s) 102 is being trained to detect objects in an environment, the input data 104 may include image data, lidar data, radar data, ultrasonic data, and/or the like. For a second example, if the model(s) 102 is being trained to perform speech processing (e.g., speech recognition, voice recognition, etc.), the input data 104 may include audio data representing speech.

The model(s) 102 may be trained using the training input data 104 as well as corresponding ground truth data 106. The ground truth data 106 may include annotations, labels, masks, and/or the like. For example, in some embodiments, the ground truth data 106 may indicate actual values of parameters 108 associated with features included in the input data 104. For instance, to continue the example from above, if the model(s) 102 are being trained to detect objects in an environment, the parameters 108 associated with an object may include, but are not limited to, x-coordinate locations, y-coordinate locations, z-coordinate locations, a height, a width, a length, a density, RGB values, and/or any other parameter. The ground truth data 106 may be generated within a drawing program (e.g., an annotation program), a computer aided design (CAD) program, a labeling program, another type of program suitable for generating the ground truth data 106, and/or may be hand drawn, in some examples. The ground truth data 106 may be synthetically produced (e.g., generated from computer models or renderings), real (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer). In some embodiments, the training data for training the model(s) 102, including the input data 104 and the ground truth data 106, may be part of a dataset obtained for a training process (e.g., software framework, script, etc.) by loading or otherwise including at least one library (e.g., software library) associated with the dataset during the training process.

As shown in FIG. 1A, a training system 110 may include a training engine 112 and a model metadata generator 114. The training engine 112 may use one or more loss functions that measure loss (e.g., error) in output data 116 generated by the model(s) 102 (based at least on the input data 104) as compared to the ground truth data 106. Any type of loss function may be used, such as cross entropy loss, mean squared error, mean absolute error, mean bias error, and/or other loss function types. In some embodiments, different outputs may have different loss functions. For instance, continuing the example from above, the x-coordinate locations may include a first loss, the y-coordinate locations may include a second loss, the z-coordinate locations may include a third loss, and/or so forth. In some embodiments, multiple losses may be combined to form a total loss, and the total loss may be used to train (e.g., update the parameters of) the model(s) 102.

The training system 110 may initiate a training process to train the model(s) 102 as described herein, and the model metadata generator 114 may generate model metadata 118 during the training process. In some embodiments, the model metadata generator 114 may include or correspond to one or more first libraries that include one or more instructions for obtaining the model metadata 118 associated with the model(s) 102. In some embodiments, the model metadata 118 may include one or more attributes associated with the model(s) 102. The attribute(s) may include, but is not limited to, a name and/or an identifier of the model(s) 102, names and/or identifiers of one or more datasets used to train the model(s) 102, a size of the dataset and/or training data 104, a number of epochs using for the training, a license type associated with the model(s) 102, a risk sore associated with the model(s) 102, bias scores associated with the model(s) 102, losses associated with the model(s) 102, and/or the like. The model metadata 118 may indicate, but is not limited to, intended use cases for the model(s) 102, out-of-scope applications for the model(s) 102, expected users of the model(s) 102, how the model(s) 102 perform with different demographic groups, information about the input data 104 and/or ground truth data 106 used to train and/or verify the model(s) 102, limitations of the model(s) 102, hardware (e.g., CPU, RAM, GPU, etc.) requirements for executing the model(s) 102, and/or ethical considerations associated with the model(s) 102.

In some embodiments, the training system 110 may modify the training process for training the model(s) 102 such that, during the training process, the model metadata 118 associated with the model(s) 102 is automatically obtained or otherwise determined. For example, the training engine 112 used during the training process may include one or more second libraries that include one or more second instructions for training the model(s) 102. The training system 110 may, in some embodiments, wrap the second library (ies) of the training engine 112 with the first library (ies) of the model metadata generator 114 for obtaining the model metadata 118. In this way, the functionality of the first library (ies) of the model metadata generator 114 may be extended to the training process and/or the second library (ies) of the training engine 112, and the model metadata 118 may be obtained or otherwise determined during at least a portion of the training process. In some embodiments, the modified training process may train the model(s) 102 during a first portion of the process, obtain/determine the model metadata 118 during a second portion of the process, and store the model metadata 118 in association with the model(s) 102 during a third portion of the process. In some embodiments, a first period of time associated with the first portion of the training process (e.g., the modified training process) may be the same as, overlap, or be different from a second period of time associated with the second portion of the training process. That is, the model metadata 118 may be obtained/determined while the model is being trained and/or after the model has completed training. Additionally, or alternatively, a third period of time associated with the third portion of the modified training process may be the same as, overlap, or be different from the first and/or second period of time. For example, the model metadata 118 may be stored while the model metadata is being obtained/determined (e.g., store a first portion of the model metadata while a second portion of the model metadata is being obtained/determined) and/or after an entire portion of the model metadata has been obtained/determined.

In some embodiments, the model metadata generator 114 may compute one or more model uncertainty values associated with the model(s) 102 and store these values as part of the model metadata 118. For instance, the model metadata generator 114 may use one or more algorithms to calculate risks associated with the model(s) 102, bias associated with the model(s) 102, variances associated with the model(s) 102, confidence intervals associated with the model(s) 102, calibration values associated with the model(s) 102, and/or the like.

In some embodiments, the training system 110 may store the model metadata 118 in association with the model(s) 102. For instance, during the training process and/or thereafter, the training system 110 may store the trained model(s) 102 and/or the model metadata 118 in association with one another in one or more database(s) 120. The database(s) 120 may represent or include one or more software repositories. By way of example, and not limitation, the system(s) may store the model metadata 118 within and/or in association with one or more model archive(s) 122 associated with the model(s) 102. The model archive(s) 122 may include one or more packaged and/or versioned representations of trained versions of the model(s) 102 along with its associated model metadata 118 (e.g., model cards), dependencies, and/or other necessary resources for deployment and inference. In some embodiments, the model metadata 118 may represent or include one or more model cards that include at least a portion of the metadata associated with the model(s) 102.

In some embodiments, based at least on storing the model metadata 118 in association with the model(s) 102, end users and/or systems may easily query and/or access the model metadata 118 associated with a given model under consideration. For instance, FIG. 1B is a data flow diagram illustrating an example process 100(B) for querying the model metadata 118 and/or using the model metadata 118 to enforce execution of the model(s) 102, in accordance with some embodiments of the present disclosure. A control component 124 may obtain one or more query (ies) 126 from one or more endpoint(s) 128. In some examples, the query (ies) 126 may be associated with the endpoint(s) 128 seeking information included in the model metadata 118 and/or model card, such as training details, risk scores, bias details, hardware specifications for optimal performance, and/or the like. For example, the control component 124 may receive the query (ies) for the model metadata 118 from the endpoint(s) 128 and, in response, the controller may obtain the model metadata 118 (e.g., from the databases(s) 120, from the model archive(s) 122, etc.) and provide it to the endpoint(s) 128. In some examples, the control component 124 may include or correspond to one or more software libraries including instructions for performing the operations described herein.

In some embodiments, the control component 124 may also enforce execution of the model(s) 102 based at least on criteria checked against the model metadata 118. In this way, the control component 124 may prevent the model(s) 102 from executing in scenarios that would be, for instance, non-compliant within the constraints of an enterprise, not optimized for the execution environment, and/or the like. The enforcement of model execution at runtime may enable users and/or organizations to restrict the model(s) 102 from executing based at least on factors like license, training data, risk assessment, bias, and/or the like.

For example, the query(s) 126 received by the control component 124 and from the endpoint(s) 128 may include a request to execute one or more particular model(s) of the model(s) 102 on one or more devices associated with the endpoint(s) 128. The control component 124 may then obtain at least the model metadata 118 stored in association with that particular model(s) and evaluate the model metadata 118 with respect to one or more criteria associated with the endpoint(s) 128. In some examples, the criteria may include a policy associated with the endpoint(s) 128 (e.g., an enterprise policy, device policy, group policy, etc.) that indicates various requirements, expectations, limitations, etc. associated with the model(s) 102 that are allowed to be used in compliance with the policy. As an example, the policy may indicate, among other things, risk thresholds for models, license requirements for models, training requirements for models, etc. Additionally, or alternatively, the criteria may include hardware specifications indicating one or more limitations and/or capabilities associated with devices of the endpoint(s) 128 that are to execute the model(s) 102. For instance, the hardware specification may indicate features (e.g., type of processor, make of processor, model of processor, etc.) associated with one or more processors of the devices, memory limitations and/or capabilities associated with the devices, version numbers associated with the device, etc.

Based at least on the evaluating, the control component 124 may determine that the endpoint(s) 128 and/or its device(s) are allowed and/or capable of executing the particular model(s) requested. For instance, the control component 124 may determine that the particular model(s) is in compliance with a given set of requirements (e.g., which may be indicated in the policy), that the model is optimized for the execution environment of the endpoint(s) 128, and/or that the hardware of the endpoint(s) 128 is/are able to properly execute the particular model(s). The control component 124 may then cause data to be sent to the endpoint(s) 128 for executing the particular model(s) on the device(s). For instance, the control component 124 may cause the model archive(s) 122 corresponding to the particular model(s) to be sent to the endpoint(s) 128.

However, if the control component 124 determines that the endpoint(s) 128 and/or its device(s) are prevented from executing the particular model(s), the control component 124 may send an indication to the endpoint(s) 128. In some embodiments, the indication may indicate one or more reasons why the particular model(s) are prevented from executing on the endpoint(s) 128 systems. For example, the indication may indicate that the policy restricts the endpoint(s) 128 from executing the particular model(s) and/or that the capabilities/limitations of the device(s) of the endpoint(s) 128 may prevent the particular model(s) from being executed.

In some embodiments, the model metadata 118 may indicate a risk score(s) associated with the particular model(s), and the control component 124 may evaluate the risk score(s) with respect to a threshold risk score associated with the endpoint(s) 128 (e.g., indicated in the policy). Based at least on the evaluation, the control component 124 may determine whether or not to provide the data to the endpoint(s) 128 for executing the particular model(s). That is, if the risk score(s) for the particular model(s) meets or exceeds the risk threshold, the control component 124 may determine to preclude the particular model(s) from execution on the endpoint(s) 128, but if the risk score is less than the risk threshold, the control component 124 may determine to allow the particular model(s) to be executed by the endpoint(s) 128.

As another example, the control component 124 may determine, based at least on the model metadata 118, one or more hardware thresholds corresponding to one or more hardware capabilities for executing the particular model(s). The control component 124 may then evaluate actual capabilities associated with the device(s) of the endpoint(s) 128 with respect to the hardware threshold(s) to determine whether or not to provide the data (e.g., the model archive(s) 122) to the endpoint(s) 128 for executing the particular model(s). If the control component 124 determines the actual capabilities meet or exceed the hardware threshold(s), the control component 124 may determine to provide the particular model(s) to the endpoint(s) 128, but if the actual capabilities do not meet the hardware threshold(s), the control component 124 may determine to prevent the particular model(s) from being executed by the endpoint(s) 128.

In some embodiments, the control component 124 may propose one or more alternative (e.g., better suited, more capable, etc.) model(s) to the endpoint(s) 128. In some examples, the alternative model(s) may be proposed to the endpoint(s) 128 based at least on determining that the endpoint(s) 128 is/are prevented from executing the particular model(s). Additionally, or alternatively, the endpoint(s) 128 may query the control component 124 for model(s) 102 that meet certain criteria, prerequisites, intended purposes, etc. By way of example, and not limitation, the endpoint(s) 128 may request a model for detecting objects in an environment of a machine, that has been trained using a closed source (e.g., non-open source) dataset, and that is optimized for rural environments. Based on this request, the control component 124 may evaluate the model metadata 118 for various potential model(s) that would meet these requirements. In some embodiments, the control component 124 may further provide the model metadata 118 corresponding to these potential model(s) to the endpoint(s) 128, and the endpoint(s) 128 may select which model(s) to execute.

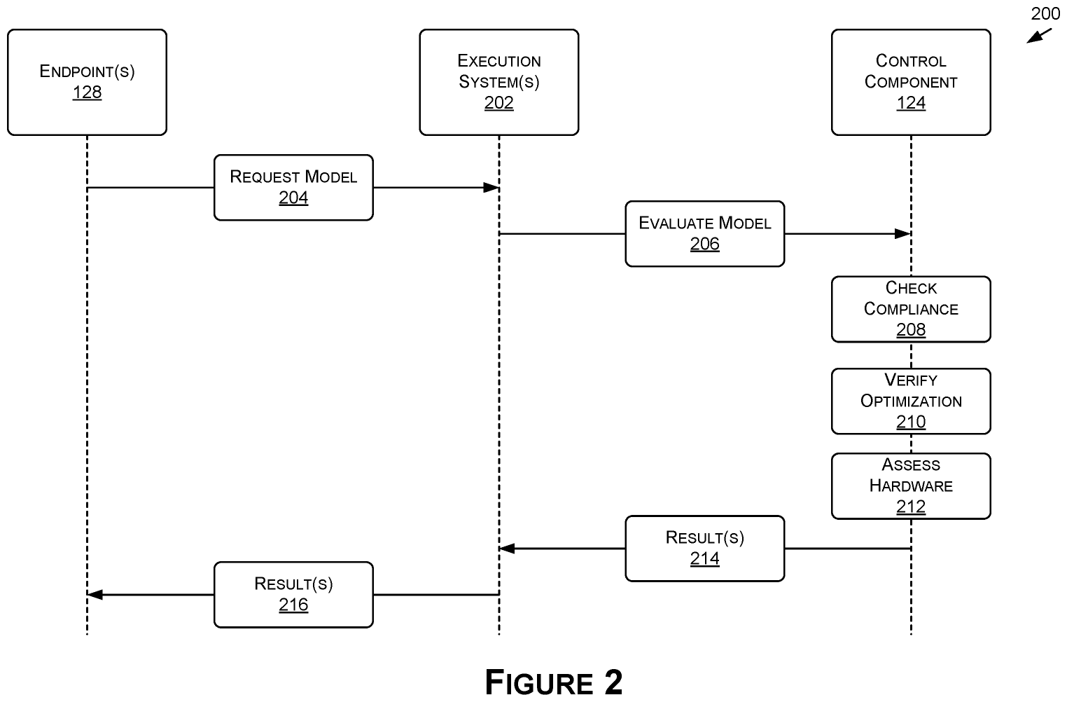

FIG. 2 is a data flow diagram illustrating an example process 200 for enforcing execution of one or more models based at least on model metadata, in accordance with some embodiments of the present disclosure. The process 200, at operation 204, includes an execution system(s) 202 receiving, from the endpoint(s) 128, a request to execute one or more particular models. In some embodiments, the execution system(s) 202 may be configured to handle such requests to execute the particular model(s).

At operation 206 of the process 200, the execution system(s) 202 may collaborate with the control component 124 to evaluate the particular model(s) and determine if the particular model(s) meet required criteria before execution. The control component 124 may validate the particular model(s) metadata against the required (e.g., predefined) criteria. For instance, at operation 208, the control component 124 may check for compliance requirements (e.g., against a policy associated with the endpoint(s) 128). Additionally, or alternatively, at operation 210, the control component 124 may verify whether the particular model(s) are optimized for the current execution environment, which may be provided by the execution system(s) 202 and/or the endpoint(s) 128. For instance, the control component 124 may verify that the particular model(s) would execute efficiently in the execution environment. Additionally, or alternatively, at operation 212, the control component 124 may assess hardware requirements for the particular model(s). In contrast to determining whether the particular model(s) are optimized for the execution environment such that they may execute efficiently, assessing the hardware may include determining whether the hardware of the execution environment is capable at all to execute the particular model(s). The operation 308, the operation 210, and the operation 212 may be performed concurrently or sequentially in any order.

At operation 214, the control component 124 may return result(s) indicating either a decision to execute the particular model(s) or reasons why the particular model(s) cannot be executed. For instance, if the particular model(s) cannot be executed, the reasons may indicate that the particular model(s) are not in compliance with the policy, that the particular model(s) are not optimized for the execution environment, and/or that the hardware of the execution environment is not able to run the particular model(s). At operation 216, the execution system(s) 202 may forward at least a portion of the result(s). For instance, the execution system(s) 202 may indicate a status associated with the model execution or an error/warning if the particular model(s) fails the validation and cannot be executed. The error/warning may, in some embodiments, include the reasons noted above.

In some embodiments, the techniques disclosed herein, such as the process 200, may be used in association with containers. For instance, a user may pull down one or more particular models and the container may use the techniques of this disclosure to determine if the particular model(s) could be executed in the container. In some embodiments, the decision to execute the particular model(s) or not may be based at least on and enterprise's or customer's policy.

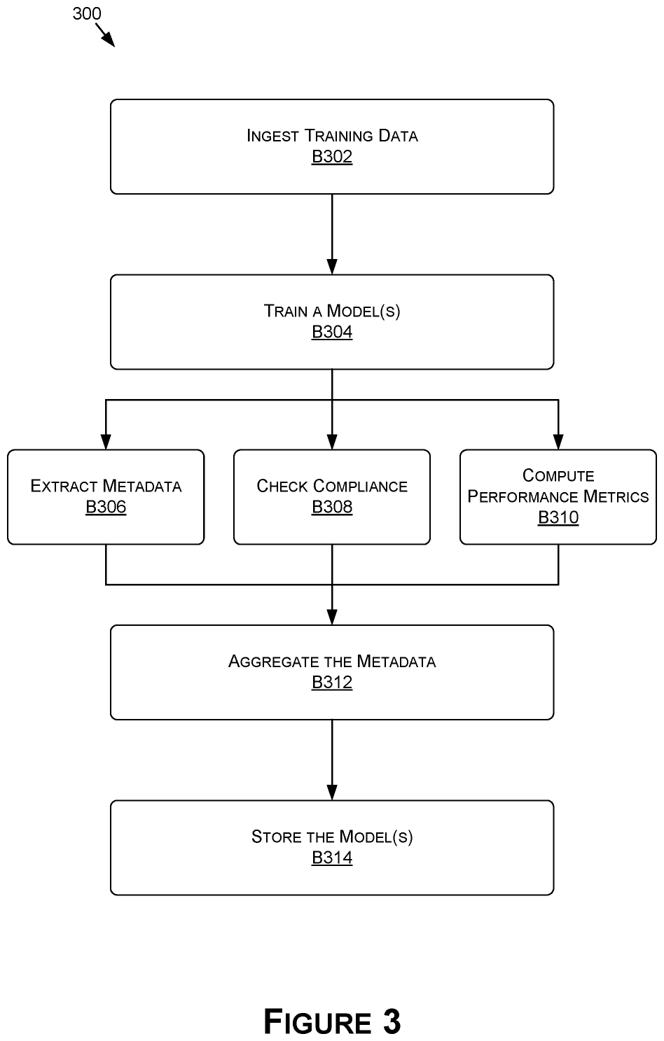

Now referring to FIG. 3, each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIGS. 1A and 1B. However, this method may additionally or alternatively be executed by any one system, or any combination of systems, including, but not limited to, those described herein.

FIG. 3 is a flow diagram illustrating an example method 300 for obtaining model metadata during a training process, in accordance with some embodiments of the present disclosure. The method 300, at block B302, includes ingesting training data. For instance, the training system 110 may obtain a training dataset including the input data 104 and/or the ground truth data 106.

At block B304, the method 300 includes training a model(s). For instance, the training system 110 may initiate a training process and use the training engine 112 to train the model(s) 102 during at least a portion of the training process. The training engine 112 may use one or more loss functions that measure loss (e.g., error) in output data 116 generated by the model(s) 102 (based at least on the input data 104) as compared to the ground truth data 106. The one or more loss functions may be combined to form a total loss, and the total loss may be used to train (e.g., update parameters of) the model(s) 102.

At block B306, the method 300 includes extracting metadata. For instance, during at least a second portion of the training process, the model metadata generator 114 may extract the metadata associated with the model(s) 102. In some embodiments, the extracted metadata may include, but is not limited to, relevant metadata from the training process, like model parameters, training duration, dataset size, etc.

At block B308, the method 300 includes checking compliance. For embodiments, the model metadata generator 114 may check the compliance of the model(s) 102 during at least a third portion of the training process. In some embodiments, checking the compliance may include, but is not limited to, determining whether the model(s) 102 adhere to certain standards or regulations.

At block B310, the method 300 includes computing performance metrics. For embodiments, the model metadata generator 114 may compute the performance metrics associated with the model(s) 102 during at least a fourth portion of the training process. In some examples, the performance metrics may include, but are not limited to, metrics such as accuracy, loss, risk, bias, F1 score, GPU requirements, ensemble characteristics, CPU & RAM requirements, data processing unit (DPU) requirements, network hardware unit requirements, and/or model size on disk. In some embodiments, the metadata extraction at block B306, the compliance check at block B308, and the performance metrics computation at block B310 may be performed concurrently or sequentially in any order.

At block B312, the method 300 includes aggregating the metadata. For instance, the model metadata generator 114 may aggregate, as the model metadata 118, the metadata extracted in block B306, the compliance checked in block B308, and/or the performance metrics computed in block B310. In some embodiments, this extracted information (e.g., metadata, compliance, performance metrics) may be combined and formatted in a filetype/definition that is easy to attach to or otherwise associated with the model(s) 102. In some embodiments, this filetype/definition may correspond to a data structure that can be accessed by an API call.

At block B314, the method 300 includes storing the model(s). For instance, the training system 110 may bundle the model metadata 118 in the model archive(s) 122 corresponding to trained versions of the model(s) 102. In some embodiments, the training system 110 may extend an open neural network exchange (ONNX) model file by adding at least a portion of the model metadata 118 (e.g., using built in programming). In contrast to conventional systems, the techniques disclosed herein may store the model in association with (e.g., in the model archive, in a database linked to the model execution file, etc.) its metadata, which may be generated during the training process.

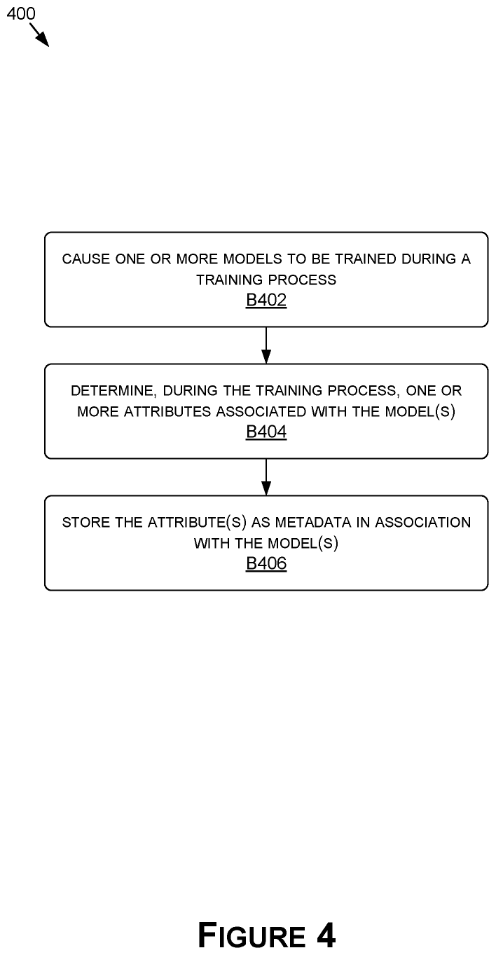

FIG. 4 is a flow diagram illustrating another example method 400 for determining model metadata during a training process and storing the model metadata in association with one or more model(s), in accordance with some embodiments of the present disclosure. The method 400, at block B402, includes causing one or more models to be trained during a training process. For instance, the training system 110 may cause the model(s) 102 to be trained during a portion of the training process using the training engine 112.

At block B404, the method 400 includes determining, during the training process, one or more attributes associated with the model(s). For instance, the training system 110 may determine the attribute(s) associated with the model(s) 102 using the model metadata generator 114 during a second portion of the training process. In some embodiments, to determine the attribute(s) the training system 110 may generate one or more first libraries and one or more instances, use the instance(s) to capture parameters from trusted sources prior to training, to evoke the model training, and/or to calculate performance metrics associated with the model(s). For instance, the training system 110 may wrap one or more second libraries for training the model(s) with the first library (ies) to generate the metadata such that, during the training process, the model is trained and the metadata is determined and stored in association with the model.

At block B406, the method 400 includes storing the attribute(s) as metadata in association with the model(s). For instance, the training system 110 and/or the model metadata generator 114 may store the attribute(s) as the model metadata 118 in association with the model(s) 102. In some embodiments, the model metadata 118 may be stored in the model archive(s) 122 in the database(s) 120. In some embodiments, the metadata may be stored in one or more same locations as the model(s) and/or data used to run the model(s) (e.g., in a same file, in a same directory, in a same database, etc.).

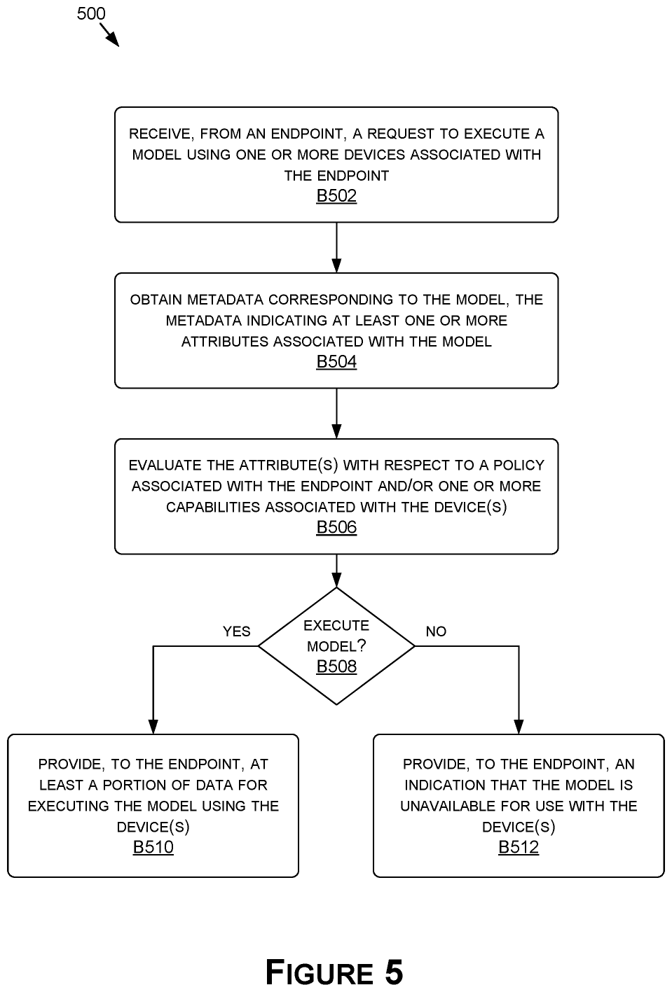

FIG. 5 is a flow diagram illustrating an example method 500 for enforcing execution of one or more models based at least on model metadata stored in association with the model(s), in accordance with some embodiments of the present disclosure. The method 500, at block B502, includes receiving, from an endpoint, a request to execute a model using one or more devices associated with the endpoint. For instance, the control component 124 may receive the query (ies) 126 indicating the request to execute the model using the device(s) associated with the endpoint(s) 128. In some embodiments, the endpoint may be associated with a user or a system requesting the model for execution.

At block B504, the method 500 includes obtaining metadata stored in association with the model, the metadata indicating at least one or more attributes associated with the model. For instance, the control component 124 may obtain the model metadata 118 stored in association with the model (e.g., in the model archive(s) 122). In some embodiments, the attribute(s) may include, but are not limited to, an indication of a dataset(s) used to train the model(s), a size of the dataset(s), a number of epochs associated with the training, a license type(s) associated with the model(s), a risk sore(s) associated with the model(s), a bias score(s) associated with the model(s), losses associated with the model(s), an intended use case(s) for the model(s), an out-of-scope application(s) for the model(s), an expected user(s) of the model(s), how the model(s) perform with different demographic groups, limitations of the model(s), a hardware requirement(s) for executing the model(s), and/or ethical considerations associated with the model(s).

At block B506, the method 500 includes evaluating the attribute(s) with respect to at least one of a policy associated with the endpoint or one or more capabilities associated with the device(s). For instance, the control component 124 may evaluate the attribute(s) with respect to the policy or the capability (ies). As an example, the control component 124 may determine whether the device(s) include hardware having characteristics that meet the hardware requirement(s) indicated in the attribute(s). As another example, the control component 124 may determine whether the policy allows for open-source models to be executed by the device(s). In some embodiments, the control component 124 may obtain and/or determine the policy and/or the capability (ies) (as well as any other criteria associated with the endpoint) based at least on receiving the request for the model. In some embodiments, the policy and/or the capability (ies), as well as other criteria/requirements, may be included with the request for the model. Additionally, or alternatively, the policy, the capabilities, and/or the other criteria may be stored by the control component 124 based at least on previous queries, based at least on the endpoint(s) 128 registering for access to the model(s), based at least on information obtained from one or more profiles associated with the endpoint (e.g., a user profile, system profile, enterprise profile, etc.).

At block B508, the method 500 includes determining whether or not to allow execution of the model. For instance, the control component 124 may determine, based at least on evaluating the attribute(s) with respect to the policy and/or the capability (ies), to allow execution of the model or to restrict execution of the model. In some embodiments, the model may be allowed to execute on the endpoint if the model is in compliance (e.g., with the policy), if the model is optimized for the execution environment, and/or if the model is capable of running on the hardware associated with the execution environment. In contrast, the model may be prevented from executing on the endpoint if the model is not in compliance (e.g., with the policy), if the model is not optimized for the execution environment, and/or if the model is not capable of running on the hardware associated with the execution environment.

If, at block B508, it is determined to allow execution of the model, the method 500 may proceed to block B510. However, if it is determined, at block B508, to prevent the model from executing in the proposed execution environment, then the method 500 may proceed to block B512.

At block B510, the method 500 includes providing, to the endpoint, at least a portion of data for executing the model using the device(s). For instance, the control component 124 may send the model archive(s) 122 for executing the model to the endpoint(s) 128 based at least on determining that the models are allowed to execute on the endpoint(s) 128. The device(s) of the endpoint(s) 128 may then use information and/or data (e.g., workload images, files, etc.) contained in the model archive(s) 122 to execute the model.

At block B512, the method 500 includes sending, to the endpoint, an indication that the model is unavailable for use with the device(s). Example indication(s) may include that at least one of the policy or the capability (ies) prevents the device(s) from executing the model. In some embodiments, the indication may include a solution or remedy rectifying issue(s) that prevented the device(s) from executing the model. For instance, the control component 124 may send the indication that the policy and/or the capability (ies) prevents the model from being executed on the endpoint(s) 128 based at least on determining that the models are precluded from executing on the endpoint(s) 128.

### Example Computing Device

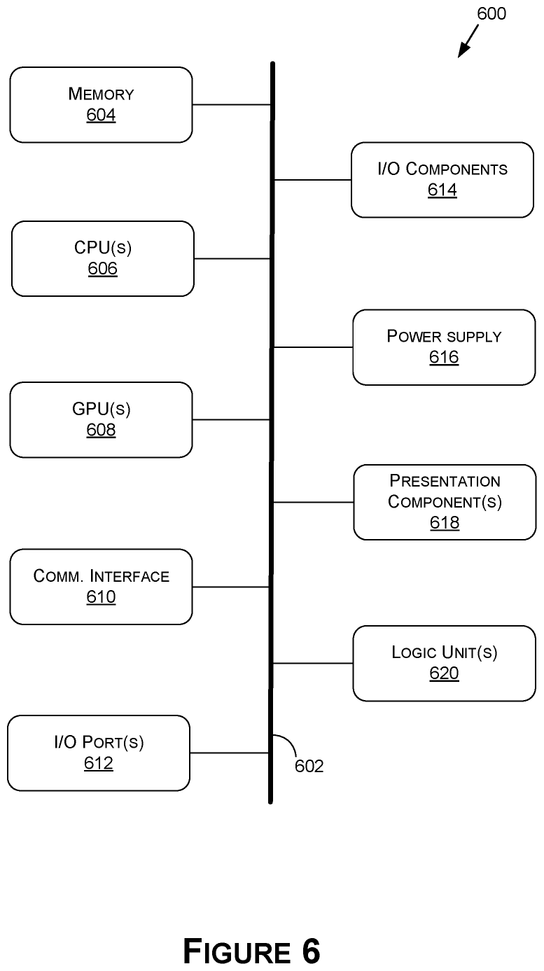

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

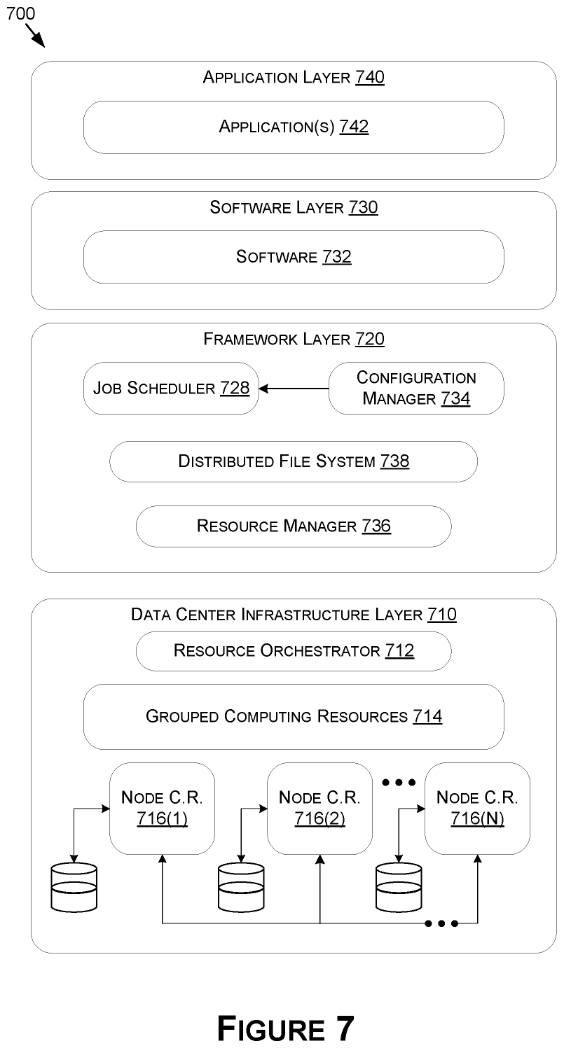

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework, such as Kubernetes or Apache Spark™ (hereinafter “Spark”), that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A. A method comprising: causing one or more models to be trained during a training process; determining, during the training process and by one or more processing units, one or more attributes associated with the one or more models; and storing the one or more attributes as metadata in association with the one or more models.
B. The method as recited in paragraph A, wherein determining the one or more attributes by one or more processing units comprises executing one or more software libraries that include one or more instructions to obtain the metadata during the training process.
C. The method as recited in any one of paragraphs A-B, further comprising wrapping one or more second software libraries of the training process using the one or more software libraries, the one or more second software libraries including one or more second instructions to train the one or more models.
D. The method as recited in any one of paragraphs A-C, wherein the one or more attributes indicate one or more hardware thresholds for one or more devices to execute the one or more models, the one or more hardware thresholds including at least one of: one or more central processing unit (CPU) thresholds, one or more memory thresholds, one or more graphics processing unit (GPU) thresholds, one or more data processing unit (DPU) thresholds, or one or more network hardware unit thresholds.
E. The method as recited in any one of paragraphs A-D, wherein the metadata is stored in association with the one or more models during the training process.
F. The method as recited in any one of paragraphs A-E, further comprising storing, in one or more model archives including data for executing the one or more models, the metadata using one or more model cards corresponding to the one or more models.
G. The method as recited in any one of paragraphs A-F, further comprising: computing, during the training process, one or more uncertainty values associated with the one or more models, the one or more uncertainty values including at least one of a first value indicating a risk score associated with the one or more models or a second value indicating a bias associated with the one or more models; and storing the one or more uncertainty values as at least a portion of the metadata in association with the one or more models.
H. The method as recited in any one of paragraphs A-G, further comprising: receiving, from an endpoint, a query for the metadata associated with a model; obtaining, based at least on the query, the metadata associated with the one or more models from one or more model archives; and providing the metadata to the endpoint.
I. The method as recited in any one of paragraphs A-H, further comprising: receiving, from an endpoint, a request to provide data for executing the one or more models at the endpoint; evaluating at least one of a policy associated with the endpoint or one or more capabilities associated with the endpoint; and determining, based at least on the evaluation of at least one of the policy or the one or more capabilities with respect to the metadata, whether to provide the data to the endpoint.
J. The method as recited in any one of paragraphs A-I, wherein at least one attribute of the one or more attributes comprises at least one of: an identifier corresponding to a model of the one or more models; information associated with one or more datasets used to train the model; license information associated with the model; a risk score associated with the model; a bias score associated with the model; or a hardware specification associated with the model.
K. A system comprising: one or more processors to: receive, from an endpoint, a request to execute a model using one or more devices associated with the endpoint; obtain metadata corresponding to the model, the metadata indicating at least one or more attributes associated with the model; evaluate the one or more attributes with respect to at least one of a policy associated with the endpoint or one or more capabilities associated with the one or more devices; and provide, to the endpoint, at least one of: at least a portion of data for executing the model using the one or more devices; or an indication that the model is unavailable for use with the one or more devices.
L. The system as recited in paragraph K, wherein the one or more attributes indicate one or more hardware thresholds for the one or more devices to execute the model, the one or more hardware thresholds including at least one of: one or more central processing unit (CPU) thresholds, one or more memory thresholds, one or more graphics processing unit (GPU) thresholds, one or more data processing unit (DPU) thresholds, or one or more network hardware unit thresholds.
M. The system as recited in any one of paragraphs K-L, wherein the evaluation comprises: determining, based at least on the metadata, a risk score associated with the model; evaluating the risk score with respect to a threshold risk score indicated in the policy; and determining, based at least on the evaluation of the risk score, whether to provide the data to the endpoint for executing the model.
N. The system as recited in any one of paragraphs K-M, wherein the evaluation comprises: determining, using the metadata, one or more hardware thresholds corresponding to one or more hardware capabilities for executing the model; evaluating the one or more hardware thresholds with respect to the one or more capabilities associated with the one or more devices; and determining, based at least on the one or more hardware thresholds, whether to provide the data to the endpoint for executing the model.
O. The system as recited in any one of paragraphs K-N, the one or more processors further to: cause the model to be trained during a training process; determine, during the training process, the one or more attributes associated with the model; and store the one or more attributes as the metadata in association with the one or more models.
P. The system as recited in any one of paragraphs K-O, the one or more processors further to: access one or more software libraries including one or more instructions for obtaining the metadata during the training process; and execute the one or more software libraries during the training process used to train the one or more models, wherein at least one of the determination of the one or more attributes or the storing of the one or more attributes is based at least on the modification of the training process.
Q. The system as recited in any one of paragraphs K-P, the one or more processors further to: determine that at least one of the policy or the one or more capabilities prevents the one or more devices from executing the model; identify, using at least one of the policy or the one or more capabilities, a second model that the one or more devices are capable of executing; and sending, to the endpoint, second metadata indicating at least one or more second attributes associated with the second model.
R. The system as recited in any one of paragraphs K-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
S. At least one processor comprising: one or more circuits to generate and store metadata during a training process for one or more models, the metadata indicating at least one or more attributes associated with the one or more models and being stored in association with the one or more models.
T. The processor as recited in any one of paragraphs 19, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system implemented using one or more large language models (LLMs); a system implemented using one or more vision language models (VLMs); a system for performing operations using a large language model; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
causing one or more models to be trained during a training process;
determining, during the training process and by one or more processing units, one or more attributes associated with the one or more models; and
storing the one or more attributes as metadata in association with the one or more models.

2. The method of claim 1, wherein determining the one or more attributes by one or more processing units comprises executing one or more software libraries that include one or more instructions to obtain the metadata during the training process.

3. The method of claim 2, further comprising wrapping one or more second software libraries of the training process using the one or more software libraries, the one or more second software libraries including one or more second instructions to train the one or more models.

4. The method of claim 1, wherein the one or more attributes indicate one or more hardware thresholds for one or more devices to execute the one or more models, the one or more hardware thresholds including at least one of:
one or more central processing unit (CPU) thresholds,
one or more memory thresholds,
one or more graphics processing unit (GPU) thresholds,
one or more data processing unit (DPU) thresholds, or
one or more network hardware unit thresholds.

5. The method of claim 1, wherein the metadata is stored in association with the one or more models during the training process.

6. The method of claim 1, further comprising storing, in one or more model archives including data for executing the one or more models, the metadata using one or more model cards corresponding to the one or more models.

7. The method of claim 1, further comprising:
computing, during the training process, one or more uncertainty values associated with the one or more models, the one or more uncertainty values including at least one of a first value indicating a risk score associated with the one or more models or a second value indicating a bias associated with the one or more models; and
storing the one or more uncertainty values as at least a portion of the metadata in association with the one or more models.

8. The method of claim 1, further comprising:
receiving, from an endpoint, a query for the metadata associated with a model;
obtaining, based at least on the query, the metadata associated with the one or more models from one or more model archives; and
providing the metadata to the endpoint.

9. The method of claim 1, further comprising:
receiving, from an endpoint, a request to provide data for executing the one or more models at the endpoint;
evaluating at least one of a policy associated with the endpoint or one or more capabilities associated with the endpoint; and
determining, based at least on the evaluation of at least one of the policy or the one or more capabilities with respect to the metadata, whether to provide the data to the endpoint.

10. The method of claim 1, wherein at least one attribute of the one or more attributes comprises at least one of:
an identifier corresponding to a model of the one or more models;
information associated with one or more datasets used to train the model;
license information associated with the model;
a risk score associated with the model;
a bias score associated with the model; or
a hardware specification associated with the model.

11. A system comprising:
one or more processors to:
receive, from an endpoint, a request to execute a model using one or more devices associated with the endpoint;
obtain metadata corresponding to the model, the metadata indicating at least one or more attributes associated with the model;
evaluate the one or more attributes with respect to at least one of a policy associated with the endpoint or one or more capabilities associated with the one or more devices; and
provide, to the endpoint, at least one of:
at least a portion of data for executing the model using the one or more devices; or
an indication that the model is unavailable for use with the one or more devices.

12. The system of claim 11, wherein the one or more attributes indicate one or more hardware thresholds for the one or more devices to execute the model, the one or more hardware thresholds including at least one of:
one or more central processing unit (CPU) thresholds,
one or more memory thresholds,
one or more graphics processing unit (GPU) thresholds,
one or more data processing unit (DPU) thresholds, or
one or more network hardware unit thresholds.

13. The system of claim 11, wherein the evaluation comprises:
determining, based at least on the metadata, a risk score associated with the model;
evaluating the risk score with respect to a threshold risk score indicated in the policy; and
determining, based at least on the evaluation of the risk score, whether to provide the data to the endpoint for executing the model.

14. The system of claim 11, wherein the evaluation comprises:
determining, using the metadata, one or more hardware thresholds corresponding to one or more hardware capabilities for executing the model;
evaluating the one or more hardware thresholds with respect to the one or more capabilities associated with the one or more devices; and
determining, based at least on the one or more hardware thresholds, whether to provide the data to the endpoint for executing the model.

15. The system of claim 11, the one or more processors further to:
cause the model to be trained during a training process;
determine, during the training process, the one or more attributes associated with the model; and
store the one or more attributes as the metadata in association with the model.

16. The system of claim 15, the one or more processors further to:
access one or more software libraries including one or more instructions for obtaining the metadata during the training process; and
execute the one or more software libraries during the training process used to train the model,
wherein at least one of the determination of the one or more attributes or the storing of the one or more attributes is based at least on the modification of the training process.

17. The system of claim 11, the one or more processors further to:
determine that at least one of the policy or the one or more capabilities prevents the one or more devices from executing the model;
identify, using at least one of the policy or the one or more capabilities, a second model that the one or more devices are capable of executing; and
sending, to the endpoint, second metadata indicating at least one or more second attributes associated with the second model.

18. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. At least one processor comprising:
one or more circuits to generate and store metadata during a training process for one or more models, the metadata indicating at least one or more attributes associated with the one or more models and being stored in association with the one or more models.

20. The processor of claim 19, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system implemented using one or more large language models (LLMs);
a system implemented using one or more vision language models (VLMs);
a system for performing operations using a large language model;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
